(19) United States
(12) Patent Application Publication
(10) Pub. No.: US 2008/0225032 A1
(43) Pub. Date: Sep. 18, 2008

(54) IMAGE FORMING APPARATUS, IMAGE FORMING SYSTEM, COMPUTER-READABLE RECORDING MEDIUM STORING IMAGE FORMING PROGRAM, AND COMPUTER-READABLE RECORDING MEDIUM STORING OPERATION CONTROL PROGRAM

(75) Inventors: Toshitsugu Nishimi, Osaka-shi (JP); Yasushi Tsukamoto, Osaka-shi (JP); Akira Fujikura, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 12/039,019

(22) Filed: Feb. 28, 2008

(30) Foreign Application Priority Data
Mar. 12, 2007 (JP) 2007-061379

(51) Int. Cl. G09G 5/00

(52) U.S. Cl. 345/211

(57) ABSTRACT

An image forming apparatus includes a display section for displaying an image associated with an operation of the apparatus. An operating section receives operating instructions and a user ID from a user. A panel display log storage section stores a panel display log which has been inputted from the operating section and associated with the user ID. A communication section transmits the panel display log to a server through a network together with the panel display log associated with the user ID and receives from the server customized display information formed in the server based on the transmitted panel display log. A customized display image forming section takes in the received customized display information and forms a customized display image to be displayed on the display section. The image display controller controls the display section to display the customized display image on the display section.

### BACKGROUND OF THE INVENTION

1. Field of the Invention

The present invention relates to an image forming apparatus, an image forming system, an image forming program, and an operation control program and, in particular, to a technology of customizing a display on a display section.

2. Description of the Related Art

There have been image forming apparatuses, such as a copying machine and a complex machine, which are provided with a display section for presenting to a user an operation guide and the like of the image forming apparatus (for example, Japanese Patent Unexamined Publication No. 2006-256182).

Further, for example, Japanese Patent Unexamined Publication No. 2006-133520 discloses an image forming apparatus which is capable of displaying default image data and user-customized display image data which is formed by modifying the default display image data as display image data to be displayed on a display screen to present to the user an operation guide and the like of the image forming apparatus. In this image forming apparatus, a customized screen for a menu screen display is created based on screen design information and customize information stored in a storage section so that the customized screen is to be displayed on a display screen. In other words, in this image forming apparatus, when a user inputs information related to size, position, kind of button to be displayed, characters to be displayed, and the like as information necessary for the changing through an operating section and the like to change a display form of the display section to be his desirable form, the inputted information is registered to the storage section as customize information, and then a screen display controller customizes and creates a customized menu screen based on the customize information and the screen design information stored in the storage section and allows the display section to display the customized menu screen, so that a menu screen which is customized to be in a user's desirable form, which is other than a default menu screen provided in the image forming apparatus, may be displayed on the display section.

However, when such image forming apparatus (image forming apparatus disclosed in Japanese Patent Unexamined Publication No. 2006-133520) is used in the case where a plurality of image forming apparatuses are installed in an office, a user needs to perform an operation to each of the image forming apparatuses to register the customize information if he would like to change a screen display form of a display screen of each image forming apparatus to be his desirable display form. Therefore, there is a problem that a customize information changing operation for setting the screen display form to include a user's desirable contents becomes burdensome.

### SUMMARY OF THE INVENTION

The present invention was made to solve the above-described problem, and its object is to allow a user to customize a display screen of an image display section of each image forming apparatus without performing an operation of setting a screen display form of a display screen of each image forming apparatus to include the user's desirable contents in the case where a plurality of image forming apparatuses which are connected through a network are used.

In other words, according to an aspect of the present invention, an image forming apparatus includes: a display section for displaying an image associated with an operation of the image forming apparatus; an operating section for receiving an instruction of an operation to the image forming apparatus; a panel display log storage section for storing a panel display log of an instruction which has been inputted from the operating section and is related to an operation to be displayed on the display section; a communication section for transmitting the panel display log stored in the panel display log storage section to a server through a network, and receiving from the server a customized display information formed in the server based on the transmitted panel display log; a customized display image forming section for taking in the customized display information received by the communication section, and forming a customized display image to be displayed on the display section based on the customized display information; and an image display controller for controlling the display section to display the customized display image which is formed in the customized display image forming section.

These and other objects, features and advantages of the present invention will become more apparent upon reading of the following detailed description along with the accompanied drawings.

### BRIEF DESCRIPTION OF THE DRAWINGS

FIG. 1 is a block diagram schematically showing an image forming system in accordance with an embodiment of the present invention.

FIG. 2 shows an example of an operating section and a display section of an image forming apparatus in accordance with the embodiment of the present invention.

FIG. 3A shows an example of a display screen of a display section of the image forming apparatus in accordance with the embodiment of the present invention.

FIG. 3B shows an example of a display screen of the display section of the image forming apparatus in accordance with the embodiment of the present invention.

### DETAILED DESCRIPTION OF THE PREFERRED EMBODIMENTS

Hereinafter, an embodiment of the present invention will be described with reference to the drawings.

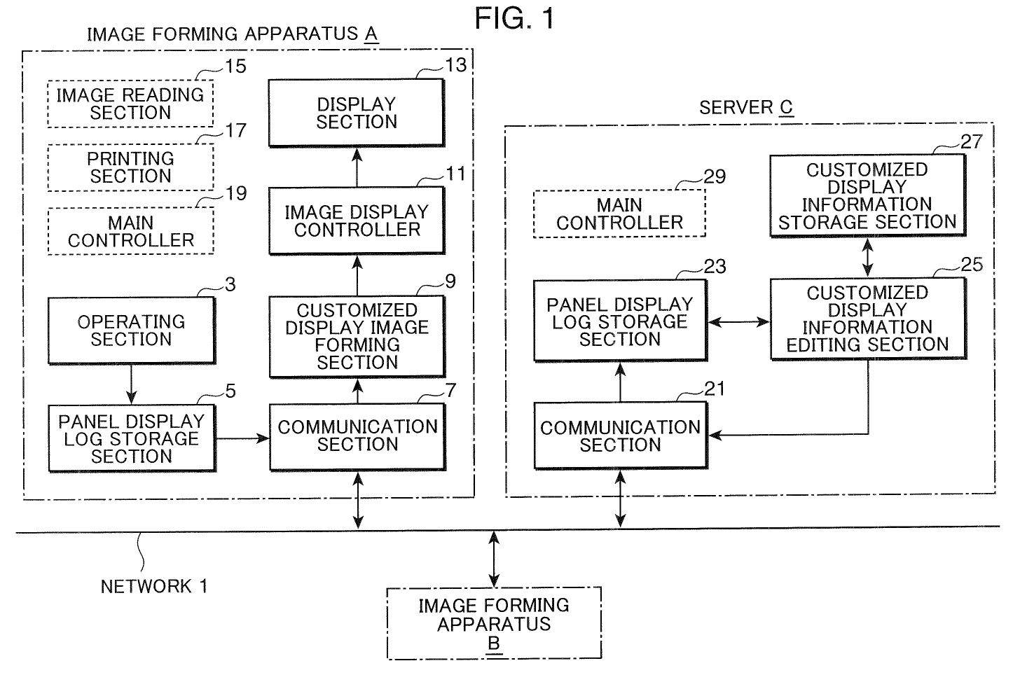

FIG. 1 is a block diagram schematically showing an image forming system in accordance with an embodiment of the present invention. It should be understood that an image forming program in accordance with an embodiment of the present invention will be described in a course of describing the image forming system as a matter of convenience.

According to FIG. 1, the image forming system in accordance with the embodiment of the present invention includes a plurality of image forming apparatuses A, B and a server C, all of which are connected through a network 1. The network 1 includes a known network such as a company LAN and the internet. Since the image forming apparatuses A, B have substantially the same configuration, only the image forming apparatus A will be described, and detailed description of the image forming apparatus B will be omitted.

Firstly, the image forming apparatus A will be described. The image forming apparatus A includes an operating section 3, a panel display log storage section 5, a communication section 7, a customized display image forming section 9, an image display controller 11, and a display section 13. Further, the image forming apparatus A (for example, a complex machine (MFP)) has an image reading section 15 as an image forming apparatus, a printing section 17, and a main controller 19.

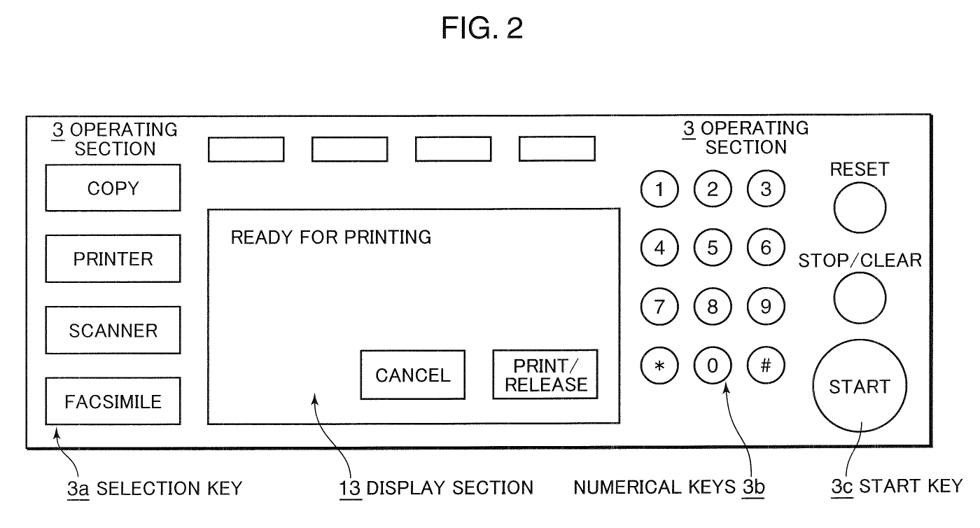

As shown in FIG. 2, the operating section 3 includes a touch-type keyboard having, for example, selection keys 3a to which operation instructions of printing (copying) processing, scanning processing, facsimile transmission processing, and the like are inputted by a user, numerical keys 3b to which change of setting items associated with those operations and a user ID (for example, employee number) specifying a user are inputted by a user, and a start key 3c to which a printing operation start instruction is inputted by a user. The operating section 3 is connected to the panel display log storage section 5. As will be described hereinafter, items inputted to the operating section 3 are displayed on the display section 13.

For example, in the image forming apparatus A, a predetermined number, which is at least one, of user ID for permitting operation to the image forming apparatus A is stored in a storage section which is not illustrated. The main controller 19 determines whether a user ID inputted to the operating section 3 by a user matches with the user ID stored in the storage section and permitting the operation. When both IDs are matching, the user who has inputted the user ID is permitted to operate the image forming apparatus A (respective sections such as the printing section 17 are operated based on an operation instruction inputted to the operating section 3 after the input of the user ID).

The panel display log storage section 5 is adapted to store input items inputted to the operating section 3 by the user as logs, and it is connected to the communication section 7.

According to an aspect of the present invention, the “log” indicates not only a mere operational status and a record of communication but also contents of operations. For example, the log includes various items such as print setting instruction (including various information such as color density and the number of printing), post-processing setting instruction, printed sheet size setting instruction, and facsimile addressee numbers. In the present embodiment, the “log” is used for a display control of the display section 13. Therefore, the “log” will be described as “panel display log” hereinafter.

The panel display log storage section 5 stores a panel display log rendered to be associated with a user ID when a user ID matching with the user ID stored in the storage section is inputted to the operating section 3.

The communication section 7 is an interface section which is adapted to send the log and profile information, which will be described hereinafter, to the server C through the network 1 in accordance with a predetermined protocol and receive customized display information, which will be described hereinafter, from the server C. The communication section 7 is connected to the network 1 and also to the customized display image forming section 9.

It should be understood that facsimile transmission/reception is also performed through the communication section 7, but description will be omitted since it is not a relevant matter of present invention.

The customized display image forming section 9 is adapted to extract customized display information from information received by the communication section 7 from the server C through the network 1 in a conventionally known method, and is connected to the image display controller 11. The customized display image forming section 9 is adapted to form a customized display image which is to be displayed on the display section 13 of the image forming apparatus based on the extracted customized display information, and is connected to the image display controller 11.

The image display controller 11 adjusts a drive power source, which applies drive power to the display section 13, in accordance with the customized display image formed in the customized display image forming section 9 to perform a display control of the customized display image.

The display section 13 includes, as shown in FIG. 2, a known liquid crystal panel provided as a part of the operating section 3 and has a touch panel function of receiving an operation which is inputted by touching a part at which an image associated with an operation of the image forming apparatus is displayed.

The image reading section 15 includes a known scanner which optically reads an image of, for example, a single page of a document or a plurality of pages of documents and applies a filtering processing and the like to create electronic image data as a print job. The printing section 17 is a known color or monochromatic image forming section which is adapted to expand the image data read by the image reading section 15 to be print image data, apply toner developing processing, transfer the toner-developed image to a print sheet, and fix the toners on the sheet.

The main controller 19 includes a CPU and a ROM storing an operation program of the CPU, and is adapted to control the operating section 3, the display section 13, the image reading section 15, the printing section 17, and the like which are described above. Further, the main controller 19 partially serves as the panel display log storage section 5, the customized display image forming section 9, and the image display controller 11.

The main controller 19 has also a function of controlling the communication section 7 to transmit profile information associated with the image forming apparatus A, for example, name of the apparatus, version of an operation program, name of consumable supplies such as toners, printing state, and installation site of the apparatus, to the server C through the network 1.

The image forming apparatus B also has substantially the same configuration as that of the image forming apparatus A, but it will be omitted from description as described above.

Next, the server C will be described.

As shown in FIG. 1, the server C includes a communication section 21, a panel display log storage section 23, a customized display information editing section 25, a customized display information storage section 27, and a main controller 29 for controlling those sections. The server C has a general configuration of a server.

The communication section 21, which is controlled by the main controller 29, is an interface section adapted to receive a panel display log from the image forming apparatuses A, B through the network 1 and output the received panel display log to the panel display log storage section 23. Further, the communication section 21 is adapted also to output customized display information received from the customized display information editing section 25 to the image forming apparatuses A, B through the network 1.

The panel display log storage section 23, which is controlled by the main controller 29, is adapted to store profile information received from the image forming apparatus A, B and the log. For example, the panel display log storage section 23 stores the profile information and the panel display log which are rendered to be associated with each user in a form of a storage table. The panel display log storage section 23 is connected to the customized display information editing section 25.

The panel display log storage section 23 learns and renews, for example, functions and designations to the image forming apparatuses A, B used by each user in accordance with profile information and panel display log and stores the same for each user.

The customized display information editing section 25 has functions of automatically forming customized display information for a user with panel display log stored in the storage table of the panel display log storage section 23 in accordance with, for example, a user ID associated with the user who uses the image forming apparatus A and received by the communication section 21 from the image forming apparatus A, and allowing the customized display information storage section 27 to store the customized displayed information.

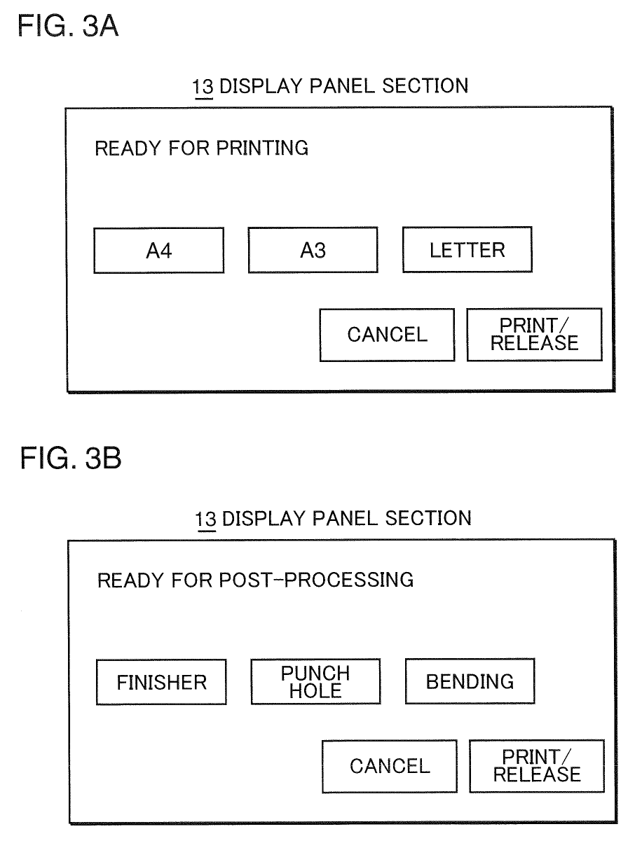

The customized display information editing section 25 refers to data stored in the storage table of the panel display log storage section 23 in accordance with a predetermined customized display information editing program stored in an unillustrated ROM or HDD provided in the server C to form customized display information for each user using the image forming apparatuses A, B. For example, (a) in the case where one user often executes copying entirely, and a user ID of the user is obtained, customized display information including image display data for displaying a copying operation screen like the one shown in FIG. 3A is formed. Further, (b) in the case where another user often executes post-processing, customized display information including image display data for displaying post-processing selection screen like the one shown in FIG. 3B is formed.

The customized display information editing section 25 has a function of reading customized display information from the customized display information storage section 27 and outputting the same to the communication section 21 at a predetermined period.

The main controller 29 includes a CPU and a ROM storing an operation program for operating the CPU, and it has a function of controlling the communication section 21, the panel display log storage section 23, the customized display information editing section 25, the customized display information storage section 27, and the like.

Next, an operation of the image forming system according to an aspect of the present invention will be described briefly.

It should be understood that the panel display log storage section 23 is presumed to store in advance the profile information and panel display log received from the image forming apparatuses A, B in the description herebelow.

When a reception processing of receiving an operation instruction and an input processing of a user ID are done by a user through the operating section 3 of the image forming apparatus A, the panel display log storage section 5 stores the received panel display log which is rendered to be associated with the inputted user ID, and the communication section 7 transmits the panel display log together with the user ID to the server C through the network 1. The communication section 7 performs a transmission processing of transmitting the panel display log and the user ID at each time when an operation reception processing is done through the operating section 3 or at a predetermined period (at a short time interval).

In the server C, under control of the main controller 29, the communication section 21 receives the panel display log and the user ID from the image forming apparatus A through the network 1, and the panel display log storage section 23 renews data stored in the storage table for each user in accordance with the received panel display log. In such a manner, panel display logs associated with each user using the image forming apparatuses A, B are renewed and accumulated in the server C.

Next, operation will be described from the viewpoint of the display control of the display section 13 of the image forming apparatus A, B. When a user inputs a user ID to the operating section 3 of the image forming apparatus A, or an operation instruction such as a copying instruction (for example, an operation performed by a user to the operating section 3 of the image forming apparatus A, including an operation of touching a “COPY” of the selection keys 3a of the operating section 3 of FIG. 2) is inputted together with the input of the user ID, the communication section 7 transmits the user ID, or transmits the panel display log and the inputted user ID to the server C through the network 1 if an operation is inputted to the operating section 3.

In the server C, similarly to the above, when a panel display log and a user ID are transmitted from the communication section 7, the communication section 21 which is under a control of the main controller 29 receives the panel display log through the network 1, and the panel display log storage section 23 renews the storage table data in accordance with the received panel display log. On the other hand, when only the user ID is transmitted from the communication section 7, the customized display information editing section 25 reads panel display log associated with the received user ID from the panel display log storage section 23, automatically forms customized display information, for example, like those shown in FIGS. 3A and 3B in accordance with the read panel display log in such a manner as described above as (a) and (b), and executes storing processing of storing the formed customized display information to the customized display information storage section 27. On the other hand, the communication section 21 transmits the customized display information to the image forming apparatus A.

In the image forming apparatus A, the communication section 7 receives the customized display information from the server C and outputs the same to the customized display image forming section 9. The customized display image forming section 9 performs a forming processing of forming a customized display image in accordance with the customized display information and outputs the customized display image to the image display controller 11. The image display controller 11 performs a display control with use of the customized display image to the display section 13 to allow the display section 13 to display the customized image like the one shown in FIG. 3A or 3B.

For example, as shown in FIG. 3A, a user can give a selection instruction such as a sheet size through a screen of the display section 13 on which a customized display as a copying operation screen is displayed. The customized display image is managed in the server C.

A program which allows a computer provided in the image forming apparatus to execute the processing steps performed by the image forming apparatus (for example, the program is stored in a ROM provided in the main controller 19 or in an unillustrated HDD) is an image forming program in accordance with the embodiment of the present invention.

Further, a program which allows the server C described above to execute the processing steps performed in the server C (for example, the program is stored in a ROM provided in the server C or in an unillustrated HDD) is an operation control program in accordance with the embodiment of the present invention.

As described above, the image forming system in accordance with the embodiment of the present invention includes a plurality of image forming apparatuses A, B and the server C for managing the image forming apparatuses, which are connected through the network 1. Each of the image forming apparatuses A, B includes the display section 13 for displaying an image associated with an operation of the image forming apparatus, the operating section 3 for receiving an instruction of an operation to the image forming apparatus, the panel display log storage section 5 for storing a panel display log of an instruction which has been inputted from the operating section 3 and is related to an operation displayed on the display section 13, the communication section 7 for transmitting the display log stored in the panel display log storage section 5 to the server C through the network 1 and receiving from the server C a customized display information formed based on the transmitted panel display log, the customized display image forming section 9 for taking in the customized display information received by the communication section 7 and forming a customized display image to be displayed on the display section 13, and the image display controller 11 for controlling the display section 13 to display the customized display image which is obtained. On the other hand, the server C includes the communication section 21 for receiving the panel display log from the image forming apparatuses A, B through the network 1 and replying the customized display information formed with the received panel log through the network 1, the panel display log storage section 23 for storing the panel display log received by the communication section 21, the customized display information editing section 25 for forming a customized display information of the image forming apparatuses A, B in accordance with the panel display log stored in the panel display log storage section 23 and allowing the communication section 21 to transmit the customized display information to the image forming apparatus A, B, and the customized display information storage section 27 for storing the customized display information.

Therefore, in the case where a plurality of image forming apparatuses A, B are installed in an office, and a user changes a screen display form of respective display sections 13 of the image forming apparatus A, B to a desirable form, the user does not need to perform individual operation to each of the image forming apparatus to register the customized information, so that a customize information changing operation for setting a screen display form to include the user's desirable contents becomes easy.

Further, since the server C gathers operation history of the image forming apparatuses A, B, and the customized display information editing section 25 automatically forms customized display information for the image forming apparatuses A, B from the panel display log in accordance with functions and setting which are often used by a user, a desirable display screen is displayed on the display section 13 without burdensome operations performed by the user.

Further, in each of the image forming apparatuses A, B, the panel display log storage section 5 stores panel display log rendered to be associated with each user, and the communication section 7 transmits the panel display log to the server C and receives customized display information for each user from the server C, and the customized display image forming section 9 and the image display controller 11 allows the display section 13 to display a customized display image, so that the display screen of the display section 13 can be customized for each user only with a user's input of his user ID through the operating section 3.

Further, transmission of a panel display log and taking in of customized display information are performed at a predetermined period in each of the image forming apparatus A, B, and the server C renews and transmits customized display information to the image forming apparatuses A, B. Therefore, customized display can be performed in each of the image forming apparatuses A, B based on a use history which is always new.

In the above-described image forming system in accordance with an embodiment of the present invention, the server C can transmit the same customized display information formed in a manner as described above to the image forming apparatuses A, B connected to the network 1, and the customized display information can be distributed to a plurality of image forming apparatuses at the same time. Therefore, when a user used any of the plurality of image forming apparatuses, the user can allow the display section 13 to display a display screen which is favorable for him only by inputting, for example, his user ID to the operating section 3.

It should be understood that it would not be necessary that the above-described server C be an independent apparatus on the network, and, for example, it can be so configured as a same kind of functional portion (for example, an internally provided computer) provided in a complex machine, a printer, or the like connected to the network 1.

Further, since each of the above-described image forming apparatuses A, B includes the operating section 3, the panel display log storage section 5, the communication section 7, the customized display image forming section 9, the image display controller 11, and the display section 13, it would not be necessary that display screens of the image forming apparatuses A, B are respectively customized in a direct manner, so that a display image can be customized by configuring the embodiment of the present invention independently.

In summary, according to an aspect of the present invention, an image forming apparatus includes: a display section for displaying an image associated with an operation of the image forming apparatus; an operating section for receiving an instruction of an operation to the image forming apparatus; a panel display log storage section for storing a panel display log of an instruction which has been inputted from the operating section and is related to an operation to be displayed on the display section; a communication section for transmitting the panel display log stored in the panel display log storage section to a server through a network, and receiving from the server a customized display information formed in the server based on the transmitted panel display log; a customized display image forming section for taking in the customized display information received by the communication section, and forming a customized display image to be displayed on the display section based on the customized display information; and an image display controller for controlling the display section to display the customized display image which is formed in the customized display image forming section.

According to the aspect of the invention, even in the case where a plurality of image forming apparatuses are installed in an office, and a user changes screen display forms of the display sections of the image forming apparatus, it would not be necessary that the user performs operation individually to each image forming apparatus to register the customize information, so that customize information changing operation for setting a screen display form to include a user's desirable content becomes easy.

Further, according to an aspect of the present invention, the communication section sends the panel display log and take in the customized display information at a predetermined period.

Further, according to an aspect of the present invention, the panel display log storage section stores a panel display log which is rendered to be associated with a user who inputs an instruction causing the panel display log, and the customized display image forming section forms a customized display image for each user based on the customized display information.

According to this aspect of the invention, a display screen of the display section can be displayed in a manner customized for each user only with a user's input of his user ID and the like to the operating section.

Further, an image forming system according to an aspect of the present invention in which an image forming apparatus and a server for managing the image forming apparatus are connected through a network, and the image forming apparatus includes: a display section for displaying an image associated with an operation of the apparatus; an operating section for receiving an instruction of an operation to the image forming apparatus; a panel display log storage section for storing a panel display log of an instruction which has been inputted from the operating section and is related to an operation; a communication section for transmitting the panel display log stored in the panel display log storage section to a server through a network and receiving from the server a customized display information formed in the server based on the panel display log; a customized display image forming section for taking in the customized display information received by the communication section and forming a customized display image to be displayed on the display section based on the customized display information; and an image display controller for controlling the display section to display the customized display image which is formed in the customized display image forming section.

Further, according to an aspect of the present invention, the server includes: a communication section for receiving the panel display log from the image forming apparatus through the network and sending the customized display information to the image forming apparatus through the network; a panel display log storage section for storing the panel display log received by the communication section; a customized display information editing section for forming a customized display information of the image forming apparatus based on the panel display log stored in the panel display log storage section and allowing the communication section to transmit the customized display information to the image forming apparatus; and a customized display information storage section for storing the customized display information.

Further, according to an aspect of the present invention, the customized display information editing section of the server automatically forms customized display information in accordance with a predetermined condition with the panel display log sent from the image forming apparatus and received by the communication section of the server.

According to this aspect of the invention, a display screen of a display section is automatically customized in accordance with a user's operation history without any input operation performed by the user to customize the display screen of the display section, so that a user's operation required for customization of the display screen of the display section is distinctly simplified.

Further, according to an aspect of the present invention, in the image forming apparatus, the panel display log storage section stores the panel display log rendered to be associated with a user who has inputted an instruction to the operating section, and the communication section transmits to the server the panel display log stored in the panel display log storage section together with associated user information, and the customized display image forming section forms a customized display image for the user in accordance with the customized display image received from the server, and in the server, the customized display information editing section forms a customized display information for each user in accordance with the panel display log and associated user information received from the image forming apparatus.

Further, according to an aspect of the present invention, in the image forming apparatus, the communication section performs transmission of the panel display log and taking in of the customized display information at a predetermined period, and in the server, the communication section of the server receives the panel display log from the image forming apparatus at a predetermined period, and the panel display log storage section stores the received panel display log, and the customized display information editing section newly forms customized display information in accordance with the stored panel display log, and the customized display information storage section stores the newly formed customized display information, and the communication section of the server transmits the customized display information stored in the customized display information storage section.

According to this aspect of the invention, a screen display of the display section can be displayed in a customized manner based on a panel display log which is always new.

Further, according to an aspect of the present invention, the communication section of the server transmits the same customized display information to every image forming apparatus connected to the network.

According to this aspect of the invention, even in the case where a user uses any of the image forming apparatuses, a display screen which is favorable for him can be displayed on the display section only by inputting, for example, his user ID to the operating section.

Further, a computer-readable recording medium according to an aspect of the present invention stores an image forming program which allows a computer provided in an image forming apparatus connected to a server through a network to serve as: an instruction reception processor for receiving an instruction of an operation to an image forming apparatus; a panel display log storing processor for storing a panel display log of an instruction which has been received by the instruction reception processor and is related to an operation to be displayed on a display section; a transmission processor for transmitting the panel display log stored in the panel display log storing processor to the server through the network; a reception processor for receiving the customized display information formed in the server based on the transmitted panel display log from the server through the network; a customized display image forming processor for taking in the received customized display information, and forming a customized display image which is to be displayed on the display section; an image display controller for allowing the display section to display the customized display image.

Further, a computer-readable recording medium according to an aspect of the present invention stores an operation control program which allows a computer as a server connected to an image forming apparatus through a network to serve as: a reception processor for receiving the panel display log from the image forming apparatus through the network; a panel display log storing processor for storing the panel display log received through the reception processing; a customized display information editing processor for forming customized display information of the image forming apparatus based on the panel display log stored in the panel display log storing processor; and a transmission processor for transmitting the customized display information formed by the customized display information editing processor to the image forming apparatus.

This application is based on Japanese Patent application serial No. 2007-61379 filed in Japan Patent Office on Mar. 12, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus comprising:
a display section for displaying an image associated with an operation of the image forming apparatus;
an operating section for receiving an instruction of an operation to the image forming apparatus;
a panel display log storage section for storing a panel display log of an instruction which has been inputted from the operating section and is related to an operation to be displayed on the display section;
a communication section for transmitting the panel display log stored in the panel display log storage section to a server through a network, and receiving from the server a customized display information formed in the server based on the transmitted panel display log;
a customized display image forming section for taking in the customized display information received by the communication section, and forming a customized display image to be displayed on the display section based on the customized display information; and
an image display controller for controlling the display section to display the customized display image which is formed in the customized display image forming section.

2. The image forming apparatus according to claim 1, wherein the communication section sends the panel display log and take in the customized display information at a predetermined period.

3. The image forming apparatus according to claim 1, wherein the panel display log storage section stores a panel display log which is rendered to be associated with each user who inputs an instruction causing the panel display log, and the customized display image forming section forms a customized display image for each user based on the customized display information.

4. An image forming system in which one or more image forming apparatuses and a server for managing the image forming apparatus are connected through a network, wherein
the image forming apparatus includes:
a display section for displaying an image associated with an operation of the apparatus;
an operating section for receiving an instruction of an operation to the image forming apparatus;
a panel display log storage section for storing a panel display log of an instruction which has been inputted from the operating section and is related to an operation;
a communication section for transmitting the panel display log stored in the panel display log storage section to a server through a network and receiving from the server a customized display information formed in the server based on the panel display log;
a customized display image forming section for taking in the customized display information received by the communication section and forming a customized display image to be displayed on the display section based on the customized display information; and
an image display controller for controlling the display section to display the customized display image which is formed in the customized display image forming section.

5. The image forming system according to claim 4, wherein
the server includes:
a communication section for receiving the panel display log from the image forming apparatus through the network and sending the customized display information to the image forming apparatus through the network;
a panel display log storage section for storing the panel display log received by the communication section;
a customized display information editing section for forming a customized display information of the image forming apparatus based on the panel display log stored in the panel display log storage section and allowing the communication section to transmit the customized display information to the image forming apparatus; and
a customized display information storage section for storing the customized display information.

6. The image forming system according to claim 5, wherein the customized display information editing section of the server automatically forms customized display information in accordance with a predetermined condition with the panel display log sent from the image forming apparatus and received by the communication section of the server.

7. The image forming system according to claim 5, wherein
in the image forming apparatus, the panel display log storage section stores the panel display log rendered to be associated with a user who has inputted an instruction to the operating section, and the communication section transmits to the server the panel display log stored in the panel display log storage section together with associated user information, and the customized display image forming section forms a customized display image for the user in accordance with the customized display image received from the server, and
in the server, the customized display information editing section forms a customized display information for each user in accordance with the panel display log and associated user information received from the image forming apparatus.

8. The image forming system according to claim 5, wherein
in the image forming apparatus, the communication section performs transmission of the panel display log and taking in of the customized display information at a predetermined period, and
in the server, the communication section of the server receives the panel display log from the image forming apparatus at a predetermined period, and the panel display log storage section stores the received panel display log, and the customized display information editing section newly forms customized display information in accordance with the stored panel display log, and the customized display information storage section stores the newly formed customized display information, and the communication section of the server transmits the customized display information stored in the customized display information storage section.

9. The image forming system according to claim 5, wherein the communication section of the server transmits the same customized display information to every image forming apparatus connected to the network.

10. A computer-readable recording medium storing an image forming program which allows a computer provided in an image forming apparatus connected to a server through a network to serve as:
an instruction reception processor for receiving an instruction of an operation to an image forming apparatus;
a panel display log storing processor for storing a panel display log of an instruction which has been received by the instruction reception processor and is related to an operation to be displayed on a display section;
a transmission processor for transmitting the panel display log stored in the panel display log storing processor to the server through the network;
a reception processor for receiving the customized display information formed in the server based on the transmitted panel display log from the server through the network;
a customized display image forming processor for taking in the received customized display information, and forming a customized display image which is to be displayed on the display section;
an image display controller for allowing the display section to display the customized display image.

11. A computer-readable recording medium storing an operation control program which allows a computer as a server connected to an image forming apparatus through a network to serve as:
a reception processor for receiving the panel display log from the image forming apparatus through the network;
a panel display log storing processor for storing the panel display log received through the reception processing;
a customized display information editing processor for forming customized display information of the image forming apparatus based on the panel display log stored in the panel display log storing processor; and
a transmission processor for transmitting the customized display information formed by the customized display information editing processor to the image forming apparatus.
